(19) United States
(12) Patent Application Publication
(10) Pub. No.: US 2011/0128237 A1
(43) Pub. Date: Jun. 2, 2011

(54) Thinned-Portion Substrates

(76) Inventors: Fletcher R. ROTHKOPF, Los Altos, CA (US); Stephen ZADESKY, Portola Valley, CA (US); Stephen Brian LYNCH, Portola Valley, CA (US); Chris D. PREST, San Francisco, CA (US); Tang Yew TAN, Palo Alto, CA (US); Kyle Harris YEATES, Palo Alto, CA (US); Shin John CHOI, Sunnyvale, CA (US); Richard Hung Minh DINH, Cupertino, CA (US)

(21) Appl. No.: 12/629,826

(22) Filed: Dec. 2, 2009

(51) Int. Cl. H01J 9/00; G06F 3/041

(52) U.S. Cl. 345/173; 445/24

(57) ABSTRACT

Thinned-portion substrates and processing of thinned-portion substrates is provided. A portion of a substrate, such as a mother glass used in touch screen manufacturing, can be thinned by forming a cavity in a surface of the substrate. Surface structures, such as touch sensing circuitry and/or display circuitry, can then be formed on the thinned portion of the substrate. For example, touch screen components can be formed as surface structures including touch sensing circuitry and display circuitry on one or more thinned substrate portions through processes including depositing, masking, etching, doping, etc. The thinned substrate portion, including the surface structures formed thereon, can then be detached from the surrounding thicker part of the substrate. In this way, for example, the surrounding thicker part of the substrate can provide structural integrity during various other manufacturing processes, while allowing surface structures to be formed directly on a thinner substrate.

### FIELD

This relates to processing a substrate with thinned portions, and more particularly, to forming touch screen components from thinned substrate portions.

### BACKGROUND

Many types of input devices are available for performing operations in a computing system, such as buttons or keys, mice, trackballs, touch sensor panels, joysticks, touch pads, touch screens, and the like. Touch screens, in particular, are becoming increasingly popular because of their ease and versatility of operation as well as their declining price. Touch screens generally can allow a user to perform various functions by touching or near touching the touch sensor panel using one or more fingers, a stylus or other object at a location dictated by a user interface (UI) including, for example, virtual buttons, keys, bars, displays, and other elements, being displayed by the touch screen. In general, touch screens can recognize a touch and the position of the touch on the touch screen, and the computing system can then interpret the touch in accordance with the display appearing at the time of the touch, and thereafter can perform one or more actions based on the touch.

In the case of some touch screens, a physical touch on the cover of the touch screen is not needed to detect a touch. For example, in some capacitive-type touch screens, fringing fields used to detect touch can extend beyond the surface of the cover, and objects approaching near the surface of the cover may be detected near the surface without actually touching the surface. Capacitive touch screens can include touch sensing circuit elements, such as a matrix of drive and sense lines of a substantially transparent conductive material, such as Indium Tin Oxide (ITO), often arranged in rows and columns in horizontal and vertical directions formed on a substantially transparent substrate, which can in some embodiments be formed from glass.

In many applications, for example portable touch screen devices, a thin glass substrate can be desirable. However, while making the glass as thin as possible can be desirable, thin glass can be difficult to handle during the manufacturing process. In general, the thinner the glass, the more delicate and difficult to handle. For example, the manufacturing processes used to make some touch sensor panels and/or LCD displays, e.g., patterning and masking sense and drive lines and other elements, sputtering substantially transparent metal, scribing and cutting, etc., can require that the mother glass be greater than a certain thickness so that the mother glass will not break during processing. This can place a lower limit on the thickness of the mother glass used for processing.

In some cases, it may be possible to thin the glass after processing. For a glass substrate whose touch sensing elements are formed on only one side of the mother glass, for example, the mother glass may be thinned after forming the touch sensing elements by, for example, masking the touch elements and placing the mother glass in an etching solution to remove glass from the other side, by polishing the other side, etc. However, these additional thinning processes can have some drawbacks, such as increased cost and risk of breakage of the substrate.

### SUMMARY

This relates to thinned-portion substrates and processing thinned-portion substrates. A portion of a substrate, such as a mother glass used in touch screen and display manufacturing, can be thinned by forming a cavity in a surface of the substrate. Surface structures, such as touch sensing circuitry and/or display circuitry, can then be formed on the thinned portion of the substrate. For example, touch screen components can be manufactured by forming surface structures including touch sensing circuitry and display circuitry on one or more thinned substrate portions through processes including depositing, masking, etching, doping, etc., of materials such as conductive materials (e.g., metal, substantially transparent conductors), semiconductive materials (e.g., polycrystalline silicon (Poly-Si)), and dielectric materials (e.g., SiO2, organic materials, SiNx). The thinned substrate portion, including the surface structures formed thereon, can then be detached from the surrounding thicker part of the substrate. In this way, for example, the surrounding thicker part of the substrate can provide structural integrity during various other manufacturing processes, while allowing surface structures to be formed directly on a thinner substrate (i.e., the thinned substrate portion). This can potentially yield thinner items, such as touch screens, in some cases with little or no modification to various other manufacturing processes.

### BRIEF DESCRIPTION OF THE DRAWINGS

FIG. 1 illustrates various example manufacturing processes according to various embodiments.

FIG. 2 illustrates an example substrate.

FIG. 3 illustrates an example substrate including cavities according to various embodiments.

FIG. 4 illustrates a cross section view of the example substrate of FIG. 3.

FIG. 5 is a flowchart of an example method of processing a substrate according to various embodiments.

FIG. 6 illustrates another example substrate including cavities with sloped walls according to various embodiments.

FIG. 7 illustrates an example substrate including a material layer formed on a thinned substrate portion according to various embodiments.

FIG. 8 illustrate an example method of forming cavities according to various embodiments.

FIG. 9 illustrates an example method of forming surface structures according to various embodiments.

FIG. 10 illustrates an example method of detaching thinned substrate portions according to various embodiments.

FIG. 11 illustrates another example method of forming surface structures and detaching thinned substrate portions according to various embodiments.

FIG. 12 illustrates another example substrate according to various embodiments.

FIG. 13 illustrates another example substrate according to various embodiments.

FIGS. 14-15 illustrate an example process of forming surface structures according to various embodiments.

FIGS. 16-17 illustrate another example process of forming surface structures according to various embodiments.

FIGS. 18, 19, and 20 illustrate an example mobile telephone, an example digital media player, and an example personal computer that each can include a touch screen and/or another integrated touch sensitive display that can include various embodiments.

### DETAILED DESCRIPTION

In the following description of example embodiments, reference is made to the accompanying drawings in which it is shown by way of illustration specific embodiments that can be practiced. It is to be understood that other embodiments can be used and structural changes can be made without departing from the scope of the various embodiments. Although specific materials and types of materials may be included in the descriptions of example embodiments, one skilled in the art will understand that other materials that achieve the same function can be used.

The following description includes examples in which a portion of a substrate, such as a mother glass used in touch screen and display manufacturing, can be thinned by forming a cavity in a surface of the substrate. Surface structures, such as touch sensing circuitry and/or display circuitry, can then be formed on the thinned portion of the substrate. The thinned substrate portion, including the surface structures formed thereon, can then be detached from the surrounding thicker part of the substrate. In this way, for example, the surrounding thicker part of the substrate can provide structural integrity during various other manufacturing processes, while allowing surface structures to be formed directly on a thinner substrate (i.e., the thinned substrate portion). This can potentially yield thinner items, such as touch screens, in some cases with little or no modification to various other manufacturing processes. It should be understood that although various embodiments may be described herein in terms of glass substrates, the disclosed embodiments are not limited to glass, but can include other substrates such as plastic.

Various example embodiments described below are directed to the manufacture of components for use in touch screen devices. For example, touch screen components can be manufactured by forming surface structures including touch sensing circuitry and display circuitry on one or more substrates, such as a mother glass, through processes including depositing, masking, etching, doping, etc., of materials such as conductive materials (e.g., metal, substantially transparent conductors), semiconductive materials (e.g., polycrystalline silicon (Poly-Si)), and dielectric materials (e.g., SiO2, organic materials, SiNx).

A touch screen with integrated touch sensing and display functionality may be manufactured by forming surface structures including touch sensing circuitry and display circuitry integrated in a display pixel stackup (i.e., the stacked material layers forming the display pixels), such as a liquid crystal display (LCD) stackup. The surface structures can include, for example, a matrix of voltage data lines and voltage gate lines to address circuit elements of the display pixels to display an image during a display phase, and to address the circuit elements of the display to sense touch during a touch sensing phase.

Although some example embodiments may be described herein in terms of integrated touch screens (touch and display circuitry integrated into a single display stackup), it should be understood that various embodiments are not so limited, but can be applicable to other types of touch screens, such as touch screens that include a separate touch sensor panel and display device. The touch sensor panel can include a substantially transparent substrate with surface structures (e.g., touch sensing circuitry) formed on one or more surfaces. The display device can include another substantially transparent substrate with surface structures (e.g., display circuitry) formed on one or more surfaces that can be positioned behind the touch sensor panel so that the touch sensing circuitry can substantially cover the viewable area of the display device. In this regard, various embodiments may be applicable to one or both of the substrates for the touch sensor panel and the display device.

While some example embodiments herein are described in reference to LCD displays, it is understood that other displays may be utilized instead of the LCD display, such as generally any electrically imageable layer containing an electrically imageable material. The electrically imageable material can be light emitting, light modulating, etc. Light emitting materials can be inorganic or organic in nature. Suitable materials can include organic light emitting diodes (OLED), polymeric light emitting diodes (PLED), etc. The light modulating material can be reflective, transmissive, etc. Light modulating materials can include, for example, electrochemical materials, electrophoretic materials such as Gyricon particles, electrochromic materials, and liquid crystal materials. Liquid crystal materials can be, for example, twisted nematic (TN), super-twisted nematic (STN), ferroelectric, magnetic, and chiral nematic liquid crystals. Other suitable materials can include thermochromic materials, charged particles, and magnetic particles.

Some of the potential advantages of various embodiments of the disclosure, such as thinness and brightness, may be particularly useful for portable devices, though use of embodiments of the disclosure is not limited to portable devices.

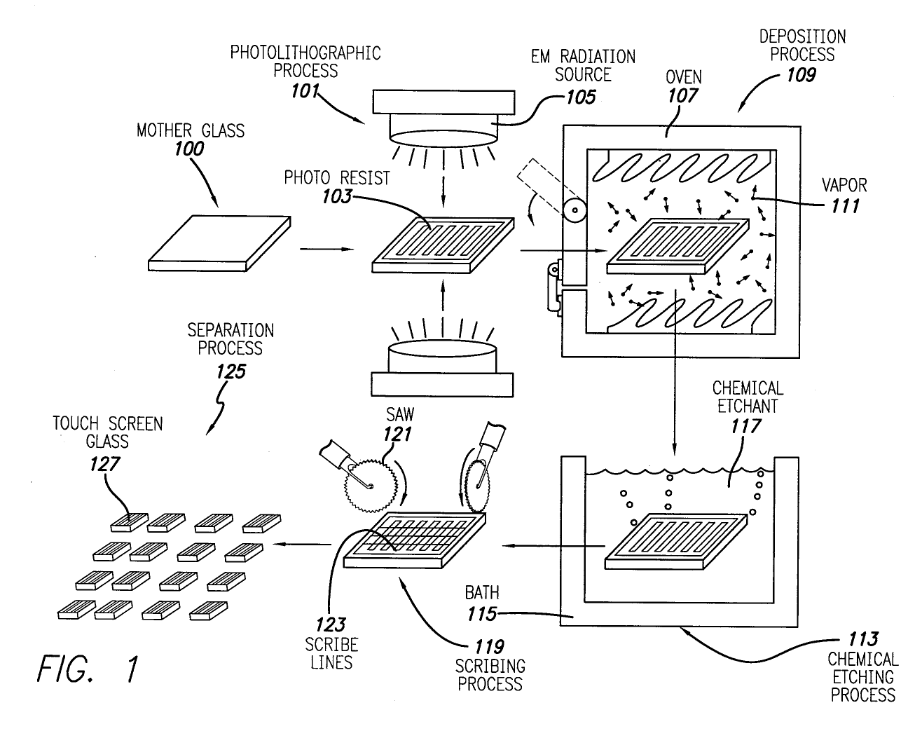

FIG. 1 shows an example manufacturing process for a touch screen, in which a mother glass 100 can be subjected to various manufacturing processes. In a first process, a photolithographic process 101 can be performed on mother glass 100. For example, process 101 can include a masking process in which a photoresist 103 can be applied to mother glass 100, and the mother glass can be then exposed to electromagnetic (EM) radiation by EM radiation source 105. Mother glass 100 may than be transferred to an oven 107 to undergo a deposition process 109, for example, a physical vapor deposition process. For example, in a physical vapor deposition process, oven 107 can be heated to high temperature, such as 200 degrees Celsius, to cause a material vapor 111 to be formed inside the oven. Material vapor 111 can impinge on the exposed areas through the mask created by photoresist 103 to create a material layer on mother glass 100. The manufacturing processes of mother glass 100 may also include etching, for example, a wet chemical etching 113. Mother glass 100 can be immersed in a bath 115 that holds a chemical etchant 117 for a period of time to allow material of mother glass 100 to be removed through a chemical etching process. For example, chemical etchant 117 may be an acid that reacts with the material of mother glass 100 and/or a material deposited on the mother glass. The etching process may be, for example, in an isotropic process, an anisotropic process, etc.

The foregoing processes may be used to form structures on the surface of mother glass 100, for example, circuit elements for multiple touch screens being formed on a single mother glass 100. A scribing process 119 can be used to aid in the separation of the individual touch screens. For example, saws 121 can create scribe lines 123 in mother glass 100. Scribe lines 123 can define the distal ends of individual touch screens. A separation process 125 can be used to separate individual touch screens 127 along scribe lines 123. Each touch screen 127 may be further processed to manufacture a touch screen device such as a portable music player, a touch sensitive cellular phone, a computer screen, etc.

In the example manufacturing process shown in FIG. 1, mother glass 100 can be transferred from process to process by various means (not shown), for example, a conveyor belt, a robotic arm, a fabrication facility employee carrying the mother glass, etc. During transport and during the various manufacturing processes, mother glass 100 may be fixed or stabilized by various means (not shown), for example, a vacuum chuck, mechanical pincers, a rack or tray, etc.

Because of the various processes, transport, and handling, substrates such as mother glass 100 can be at risk of breaking. To reduce the risk of breaking, the thickness of the substrate can be increased, for example. However, increasing the thickness may not be desirable, particularly in applications in which the substrate is used in a portable device, for example, because a thicker substrate can increase the thickness of the device, such as a touch screen.

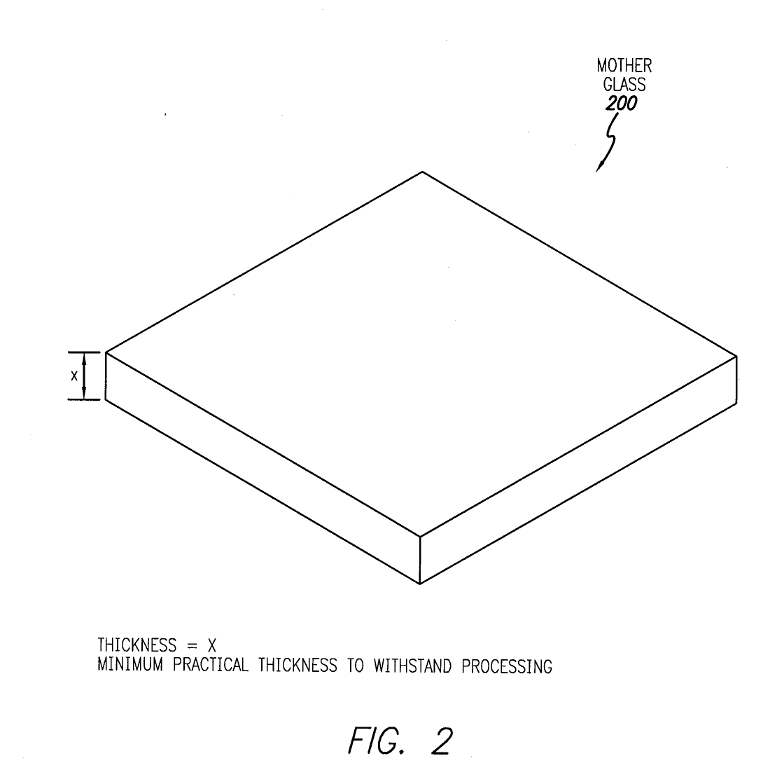

FIG. 2 illustrates an example mother glass 200 that has a constant thickness of x throughout the entire area of the mother glass. Thickness x may be, for example, a minimum practical thickness to allow mother glass 200 to withstand manufacturing processes to yield multiple individual touch screen components.

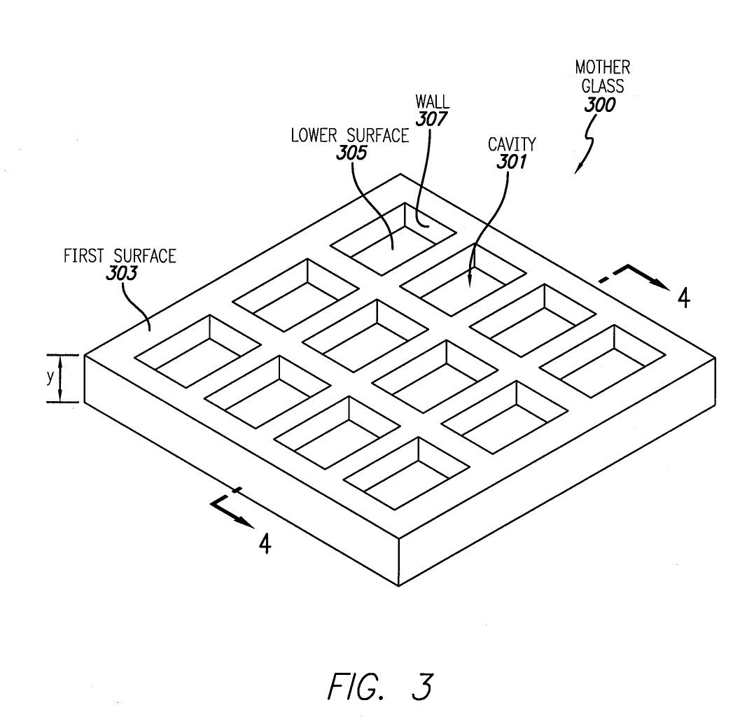

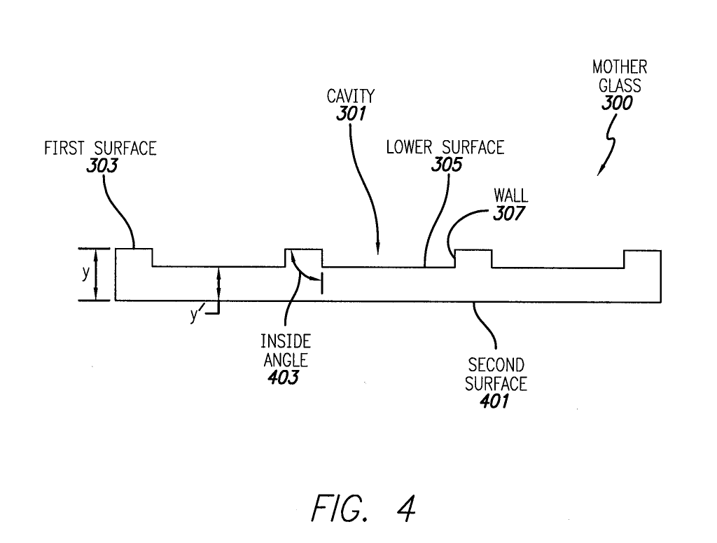

FIGS. 3-4 show an example mother glass 300 according to various embodiments. FIG. 3 shows a perspective view of mother glass 300. Mother glass 300 can have a thickness of y and can include multiple cavities 301 in a surface 303 of the mother glass. Each cavity 301 can include a lower surface 305 and walls 307.

FIG. 4 shows a cross section of mother glass 300 taken along view A-A. An inside angle 403 between first surface 303 and wall 307 can be approximately 90 degrees. FIG. 4 shows a second surface 401 opposite to lower surface 305 and first surface 303. The thickness of mother glass 300 between lower surface 305 and second surface 401 can be y′. In this example embodiment, thicknesses y and y′ can be the minimum practical thicknesses for mother glass 300 to withstand the manufacturing processes it must undergo in order to create multiple touch screen components. In some embodiments, the thickness y of other glass 300 may be greater than a thickness x of a mother glass 200 shown in FIG. 2, however, the thickness y′ of a thinned substrate region including lower surface 305 and second surface 401 may be less than the thickness x. That is, by forming cavities 301 in mother glass 300, a thinned substrate region including lower surface 305 and second surface 401 can be created that is thinner than the minimal practical thickness of a flat substrate, such as mother glass 200, that has a constant thickness throughout substantially the entire area of the substrate, e.g., does not include cavities.

In other words, one or more of the manufacturing processes illustrated in FIG. 1 can require a flat substrate, such as mother glass 200, to have a thickness that is greater than or equal to a minimum flat substrate thickness in order to prevent damage of the substrate due to the processing. On the other hand, a substrate such as mother glass 300 can be processed with the one or more manufacturing processes illustrated in FIG. 1, and the portion of mother glass 300 with thickness y can provide structural strength such that the portion of mother glass 300 with thickness y′ can be less than the minimum flat substrate thickness.

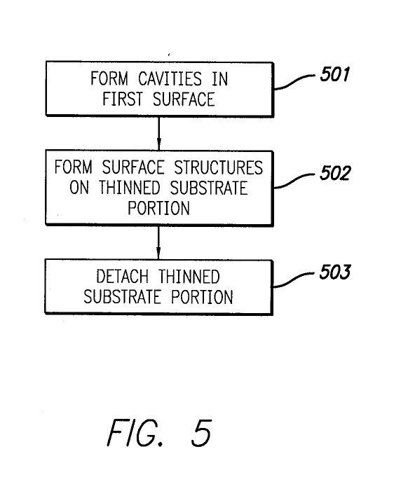

FIG. 5 is a flow chart of an example method of processing a substrate, such as mother glass 300, according to various embodiments. Cavities, such as cavities 301, can be formed (501) in a first surface of the substrate, such that each cavity includes a lower surface, such as lower surface 305, and one or more walls, such as Wall 307. The lower surface of each cavity together with a second surface of the substrate opposite to the lower surface can form a thin substrate portion. Forming the cavity can include, for example, etching the first surface. The etching may be performed, for example as an isotropic etching, anisotropic etching, wet chemical etching, laser etching, reactive ion etching (RIE), sputter etching, vapor phase etching, etc. Surface structures can be formed (502) on the thin substrate portion. Forming surface structures can include, for example, removing portions of the substrate at one of the lower surface and the second surface. For example, the lower surface can be etched by wet chemical etching, laser etching, etc., to remove a portion of the substrate material. Forming surface structures can also include forming surface structures on one of the lower surface and second surface. For example, material can be deposited on one of the surfaces of the thin substrate portion by processes such as physical vapor deposition, chemical vapor deposition, etc. The surface structures formed on the thin substrate portion can include, for example, circuit elements for touch screen glasses.

In this example, surface structures can be formed on each of the thin substrate portions to create touch screen components. For example, the surface structures can include conductive lines, such as sense lines, drive lines, gate lines, common electrodes, circuit elements such as transistors, capacitors, etc. The thin substrate portions can be detached (503) from the surrounding material at the distal ends of the thin substrate portions to create multiple independent touch screen components, each including a thinned substrate portion and the surface structures formed thereon. The thicker portions of the substrates surrounding the cavities can provide additional support and protection for the manufacturing processes that are required to form surface structures on the thinned substrate portion. In addition, the thinned substrate portion can be detached from the thicker surrounding portions of the substrate to yield a thinner touch screen component. Detaching the thin substrate portions can be done in a number of ways. For example, scribe lines can be etched into the substrate at the distal ends of the thinned substrate portion by, for example, a mechanical saw, a laser, etc., and the thinned substrate portions can be detached by a mechanical separator, for example.

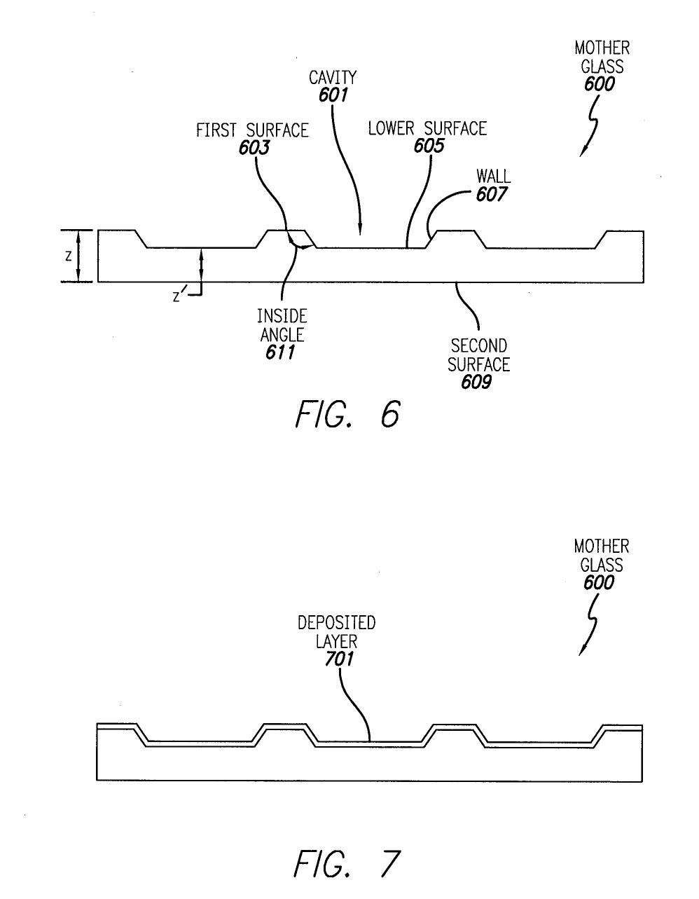

FIG. 6 shows another example substrate according to various embodiments. Mother glass 600 can include cavities 601 in a first surface 603. Each cavity 601 can include a lower surface 605 and walls 607. Mother glass 600 can have a thickness of z between first surface 603 and second surface 609, and a thinned substrate portion between lower surface 605 and second surface 609 can have a thickness of z′. Inside angle 611 between first surface 603 and wall 607 can be greater than 90 degrees; e.g., cavity 601 can have sloped walls 607. As in the previous example embodiment shown in FIGS. 3 and 4, a thinned substrate portion between lower surface 605 and second surface 609 may be thinner than the minimum practical thickness of mother glass 200 without cavities. The sloped walls 607 of cavities 601 may allow some manufacturing processes to be performed more efficiently, accurately, etc.

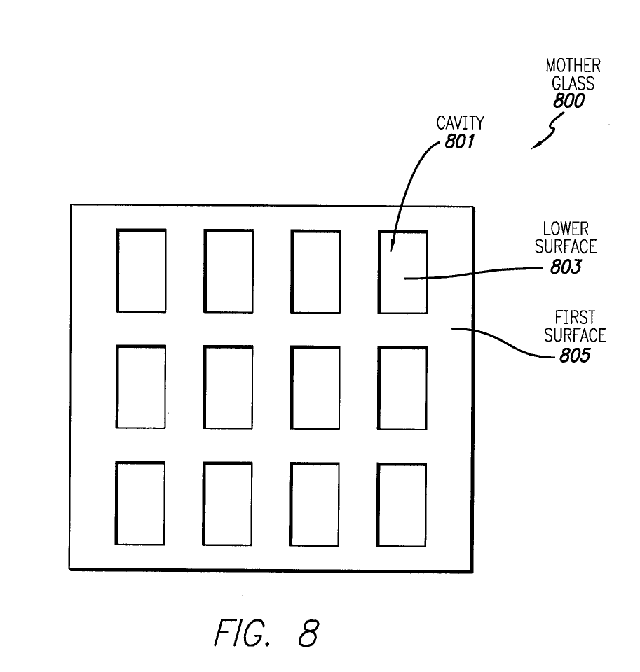

For example, FIG. 7 shows mother glass 600 after a physical vapor deposition process has deposited a layer 701. In some embodiments, sloped walls of cavities may allow easier deposition of layers such as layer 701.

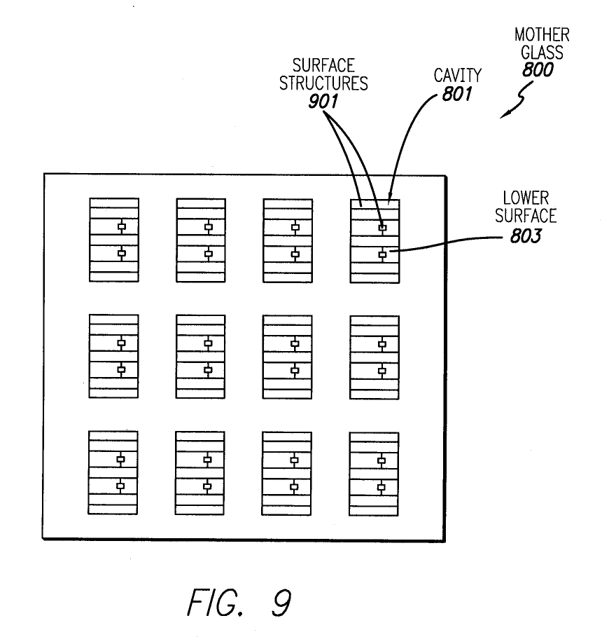

FIG. 8 shows an example mother glass 800 according to various embodiments. Mother glass 800 is shown having undergone a cavity formation process such as 501 in FIG. 5. Mother glass 800 can include cavities (801) and lower surfaces (803). In this example, the walls of cavity 801 are substantially perpendicular to a first surface 805 of mother glass 800, and therefore the walls of cavity 801 are not visible in the view shown in FIG. 8.

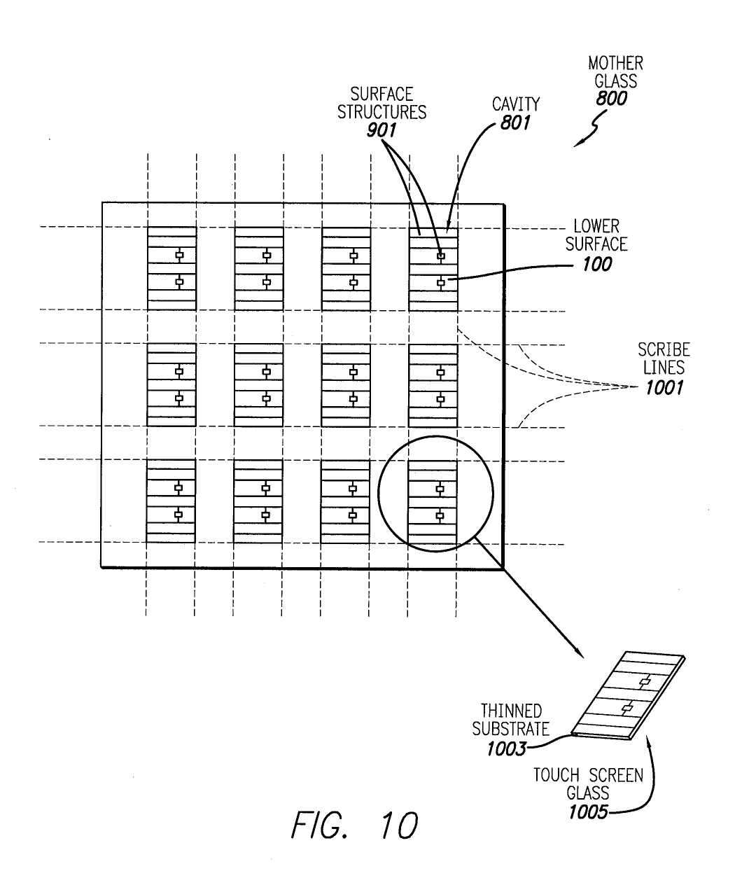

FIG. 9 shows mother glass 800 after having undergone a surface structure formation process, such as process 502 of FIG. 5. In this example, surface structures 901 have been formed on lower surface 803 of cavity 801. Surface structures 901 can be, for example, circuit elements for a touch screen component. In this example, surface structures 901 can be formed on the entire area of lower surface 803, which extends between the walls (not shown) of cavity 801.

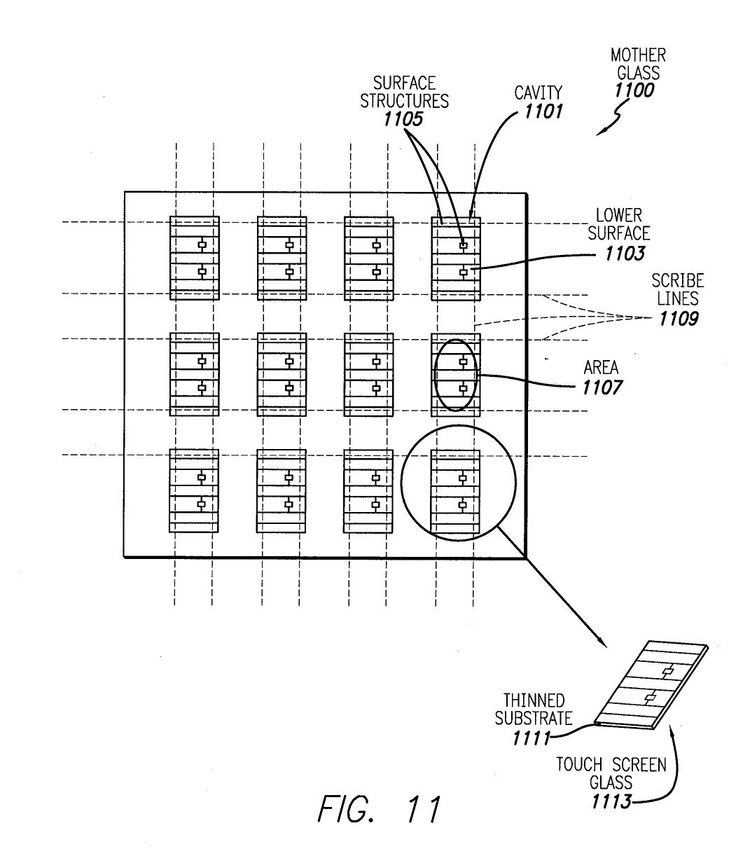

FIG. 10 shows mother glass 800 having undergone a scribing process that can be part of a detachment process such as 503 of FIG. 5. Scribe lines 1001 can be scribed into lower surface 803 at or near the walls (not shown) of cavity 801. Thinned substrate portions 1003 including lower surface 803 and surface structures 901 between scribe lines 1001 can then be detached along the scribe lines, resulting in individual touch screen components 1005. In this example, detaching can include detaching a total area of the lower surface, that is, the detaching the total area extending between the walls of the cavity.

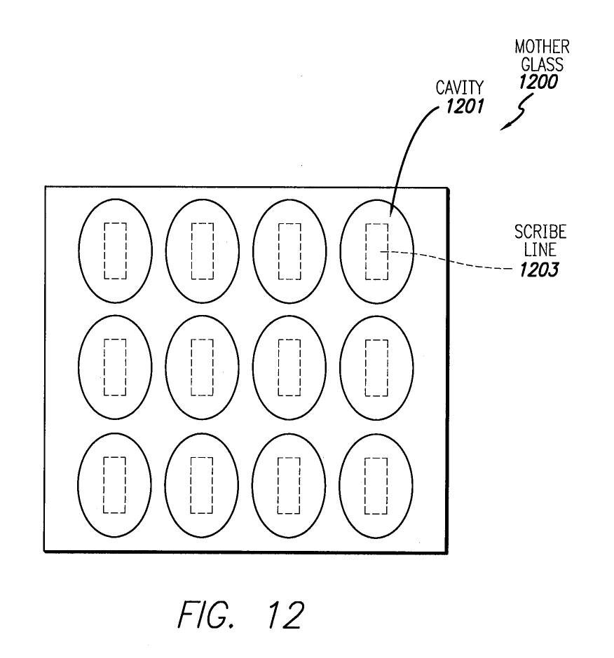

FIG. 11 shows a mother glass 1100 including cavities 1101 with lower surfaces 1103. In this example, surface structures 1105 can be formed during a surface structure formation process, such as process 502 of FIG. 5, on an area 1107 of each lower surface 1103 that can be less than a total area of the lower surface, that is, less than the total area extending between the walls of the cavity. During a detachment process, such as process 503 of FIG. 5, scribe lines 1109 can be scribed around the areas 1107, and thinned substrate portions 1111 including lower surface 1103 and surface structures 1101 in areas 1107 between scribe lines 1109 can then be detached along the scribe lines, resulting in individual touch screen glasses 1113. In this example, detaching can include detaching an area of the lower surface that can be less than a total area of the lower surface, that is, less than the total area extending between the walls of the cavity.

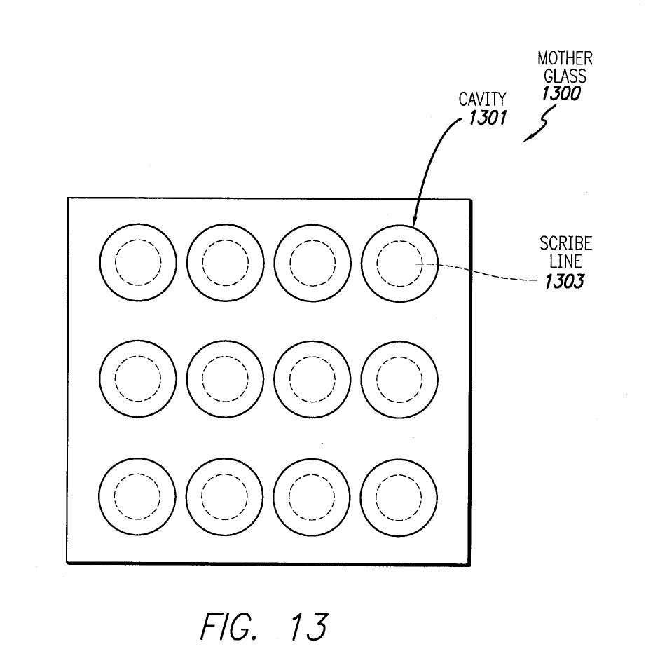

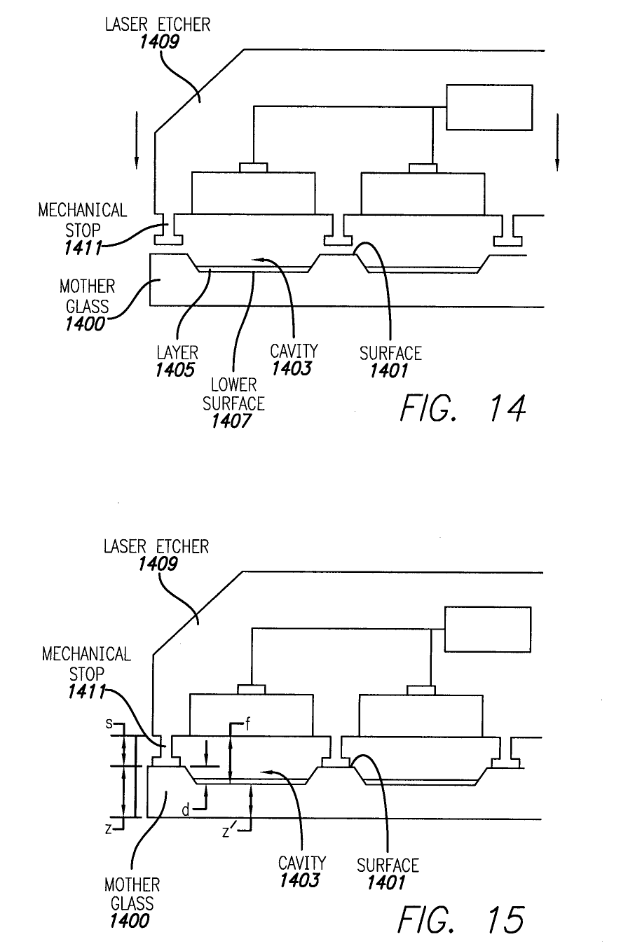

FIGS. 12-13 show a mother glasses including cavities and scribe lines of different shapes. FIG. 12 shows a mother glass 1200 including elliptical cavities 1201 and rectangular scribe lines 1203. FIG. 13 shows a mother glass 1300 including circular cavities 1301 and circular scribe lines 1303. Other shapes and dimensions of cavities, thinned substrate portions, scribe lines, etc., may be utilized, as one skilled in the art will understand.

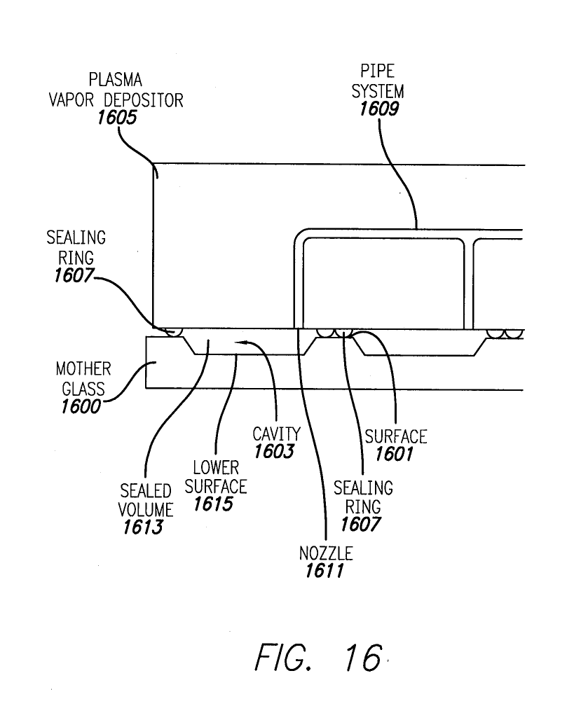

FIGS. 14-15 show an example process of forming surface structures according to various embodiments. FIG. 14 shows a mother glass 1400 including a surface 1401 with cavities 1403. A layer 1405 of material has been deposited on a lower surface 1407 of cavities 1403 during a previous process. In the present example, surface structure forming equipment, such as a laser etcher 1409 for removing portions of material layer 1405, can be positioned by positioning mechanical stops 1411 of the laser etcher against surface 1401. FIG. 15 shows laser etcher 1409 positioned with mechanical stops 1411 abutting surface 1401. The sum of the length, s, of mechanical stops 1411 and the depth, d, of cavities 1403 can equal the focal length, f, of laser etcher 1409. In this way, for example, it can be possible to more easily and accurately position a surface structure forming equipment using the depth of the cavities to position the equipment.

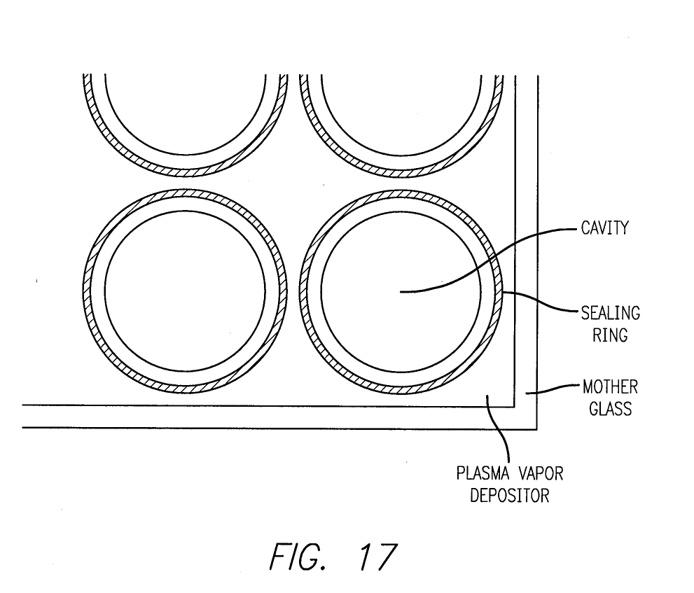

FIGS. 16-17 show another example process of forming surface structures according to various embodiments. FIG. 16 shows a mother glass 1600 including a surface 1601 with cavities 1603. Surface structure forming equipment, such as plasma vapor depositor 1605 can include sealing rings 1607 and a pipe system 1609 with nozzles 1611. FIG. 17 shows a top view of the configuration in FIG. 16. Plasma vapor depositor 1605 can be positioned by positioning sealing rings 1607 against surface 1601 to form a sealed volume 1613 including the volume of cavity 1603. A gas, such as an inert gas, can be injected into sealed volume 1613 through nozzle 1611 of pipe system 1609. Sealing rings 1607 can keep the inert gas contained in volume 1613 to maintain an inert environment for deposition of a material layer onto a lower surface 1615, for example, by plasma vapor depositor 1605. In some embodiments, other surface structure forming equipment may create sealed volumes including cavities and, for example, inject other substances, such as caustic gases, etching liquids, physical vapors for deposition, plasmas, etc., pull a vacuum on the sealed volume, and/or pressurize the sealed volume.

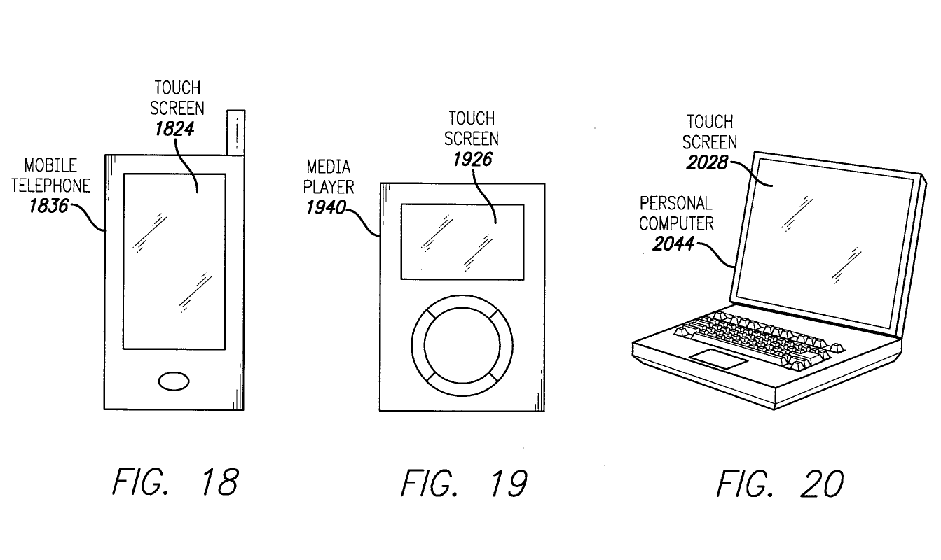

FIG. 18 illustrates an example mobile telephone 1800 that can include a touch screen 1804 and/or another integrated touch sensitive display that can include various embodiments described herein, for example.

FIG. 19 illustrates an example digital media player 1900 that can include a touch screen 3004 and/or another integrated touch sensitive display that can include various embodiments described herein, for example.

FIG. 20 illustrates an example personal computer 2000 that can include a touch screen 2004 and/or another integrated touch sensitive display that can include various embodiments described herein, for example.

The mobile telephone, media player, and personal computer of FIGS. 18-20 can be thinner and lighter, and their manufacture can benefit from reduce cost through processing various substrates in accordance with various embodiments described herein, for example.

Although embodiments have been fully described with reference to the accompanying drawings, it is to be noted that various changes and modifications will become apparent to those skilled in the art. Such changes and modifications are to be understood as being included within the scope of the various embodiments as defined by the appended claims.

What is claimed is:

1. A method of processing a substrate having a first surface, the method comprising:
forming a cavity in the first surface, the cavity including a lower surface and one or more walls, such that a thinned substrate portion includes the lower surface and a second surface of the substrate opposite to the lower surface;
forming surface structures on the thinned substrate portion; and
detaching the thinned substrate portion after forming the surface structures.

2. The method of claim 1, wherein the surface structures include one of touch sensing circuit elements and display circuit elements.

3. The method of claim 1, wherein the substrate is glass.

4. The method of claim 1, wherein forming the cavity includes etching the first surface.

5. The method of claim 1, wherein the one or more walls of the cavity are substantially perpendicular to the first surface.

6. The method of claim 1, wherein an inside angle between the first surface and one of the one or more walls of the cavity is greater than ninety degrees.

7. The method of claim 1, wherein forming the surface structures includes forming a layer of material on one of the lower surface and the second surface.

8. The method of claim 7, wherein forming the surface structures further includes removing portions of the material layer.

9. The method of claim 1, wherein forming the surface structures includes forming surface structures on the lower surface and the second surface.

10. The method of claim 1, wherein forming the surface structures includes positioning mechanical stops of surface structure forming equipment against the first surface.

11. The method of claim 1, wherein forming the surface structures includes forming a seal between surface structure forming equipment and the first surface, the seal creating a closed volume including the cavity.

12. The method of claim 11, wherein forming the surface structures includes injecting an inert gas into the closed volume.

13. The method of claim 1, wherein detaching the thinned substrate portion includes detaching a total area of the lower surface, the total area extending between the walls of the cavity.

14. The method of claim 1, wherein detaching the thinned substrate portion includes detaching an area of the lower surface that is less than a total area of the lower surface, the total area extending between the walls of the cavity.

15. The method of claim 1, wherein detaching includes scribing distal ends of one of the lower surface and the second surface.

16. A method of forming a substrate with surface structures, comprising:
forming the surface structures on a mother substrate, the mother substrate including a first portion with a first thickness and a second portion with a second thickness less than the first thickness, wherein the surface structures are formed on the second portion; and
detaching the second portion from the first portion, the detached second portion being the substrate with the surface structures.

17. The method of claim 16, wherein the surface structures include one of touch sensing circuit elements and display circuit elements.

18. The method of claim 16, wherein the mother substrate is glass.

19. The method of claim 16, wherein forming the surface structures includes forming surface structures on an upper surface and forming surface structures on a lower surface opposite to the upper surface.

20. The method of claim 16, further comprising an additional process including one of masking the mother substrate, doping the mother substrate, depositing a material on the mother substrate, and etching the mother substrate, wherein the second thickness is less than a minimum flat substrate thickness of one of the additional process, the forming the surface structures, and the detaching the second portion.

21. A touch screen device incorporating a touch sensitive surface including a substrate with surface structures formed according to the method of claim 16.
